(19) United States
(12) Patent Application Publication
(10) Pub. No.: US 2008/0037740 A1
(43) Pub. Date: Feb. 14, 2008

(54) INTELLIGENT RING-BACK INDICATOR

(75) Inventors: John H. Yoakum, Cary, NC (US); Steve J. McKinnon, Cary, NC (US)

Correspondence Address: WITHROW & TERRANOVA, P.L.L.C., 100 REGENCY FOREST DRIVE, SUITE 160, CARY, NC, 27518, US

(73) Assignee: NORTEL NETWORKS LIMITED, St. Laurent (CA)

(21) Appl. No.: 11/463,181

(22) Filed: Aug. 8, 2006

(51) Int. Cl. H04M 15/06; H04M 1/56

(52) U.S. Cl. 379/142.01

(57) ABSTRACT

The present invention allows a called party to effectively control a ring-back indicator that is presented to callers for incoming calls. For a given called party, ring-back service rules are created to control selection of a ring-back indicator based on desired ring-back criteria. When a call is being presented to the called party, the ring-back service rules are used to select a ring-back indicator to provide to the caller based on the available ring-back criteria. The ring-back indicator may be selected from available ring-back indicators. Alternatively, selection of the ring-back indicator may involve dynamically creating the ring-back indicator based in part on the ring-back criteria or other information. As the ring-back criteria changes for different calls, the ring-back indicators provided to each call may change.

### FIELD OF THE INVENTION

The present invention relates to telephony communications, and in particular to dynamically controlling a ring-back indicator to provide to a caller when a call is being presented to a called party.

### BACKGROUND OF THE INVENTION

As telecommunications have evolved, there have been numerous efforts to make communications more effective. Efforts are underway to provide presence information, which is information bearing on the relative available of a party for communications, to individuals that are interested in initiating communications with that party. As a result, presence systems are being developed to learn information about a particular person and provide presence information to others about that person. The presence information may dictate when and how to communicate with the person. For example, the presence information may indicate whether or not a person is engaged in another call or in a meeting and unavailable for telephone communications. The presence information may indicate that the person is available for instant messaging or email communications. The presence information is generally made available about a person before communications are initiated, or if communications have been initiated, the presence information is used to route communications to a particular device.

Unfortunately, presence systems are relatively new and are not in widespread use. Although presence information is useful to potential callers, the presence information is generally not made available to the caller in association with making a call to a particular called party. Instead, when a call is initiated to a called party from a caller, the caller is only presented with a ring-back tone until the call is answered or forwarded to voicemail. The ring-back tone is simply an audible ringing tone that is provided to the caller when the call is being presented to the called party's telephone. The ring-back tone indicates that the called party's telephone is ringing or otherwise alerting the called party that there is an incoming call. No other information is conveyed.

In certain packet-based telephony systems, the ring-back tone may be configured on a static basis. In essence, the called party may select a particular ring-back tone to be presented to all callers until the ring-back tone is changed. As such, the ring-back tone is purely aesthetic and cannot provide any information about the called party or circumstances surrounding the called party.

Given the desire to provide callers with information pertaining to the called party, the present invention employs a dynamically configurable ring-back tone or indicator to convey information pertaining to the called party to a caller, as a call from the caller is presented to the called party.

### SUMMARY OF THE INVENTION

The present invention allows a called party to effectively control a ring-back indicator that is presented to callers for incoming calls. For a given called party, ring-back service rules are created to control selection of a ring-back indicator based on desired ring-back criteria. When a call is being presented to the called party, the ring-back service rules are used to select a ring-back indicator to provide to the caller based on the available ring-back criteria. The ring-back indicator may be selected from available ring-back indicators. Alternatively, selection of the ring-back indicator may involve dynamically creating the ring-back indicator based in part on the ring-back criteria or other information. As the ring-back criteria changes for different calls, the ring-back indicators provided during the calls may change.

The ring-back criteria may be relatively fixed or dynamic and may take various forms. The ring-back criteria used by the ring-back service rules may include presence, location, time zone, and scheduling information of the called party; caller information; date; time of day; device settings; network conditions; as well as any preferences or input of the called party. The present invention may be employed in packet and circuit-switched networks by one or more call processing nodes.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a block representation of a communication environment according to a first embodiment of the present invention.

FIGS. 2A and 2B are a communication flow illustrating operation of the present invention in the communication environment of FIG. 1.

FIG. 3 is a block representation of a communication environment according to a second embodiment of the present invention.

FIGS. 4A and 4B are a communication flow illustrating operation of the present invention in the communication environment of FIG. 3.

FIG. 5 is a block representation of a session management server according to one embodiment of the present invention.

FIG. 6 is a block representation of a called party proxy according to one embodiment of the present invention.

FIG. 7 is a block representation of a mobile switching center according to one embodiment of the present invention.

FIG. 8 is a block representation of a feature server according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

A ring-back tone is the ringing tone that a caller hears as a call is being presented to a called party. Instead of providing a set ring-back tone, the present invention allows the called party to effectively control a ring-back indicator that is presented to callers for incoming calls. The ring-back indicators for the present invention may be any audio segments and are not limited to traditional ring-back tones. For a given called party, ring-back service rules are created to control selection of a ring-back indicator based on ring-back criteria. When a call is being presented to the called party, the ring-back service rules are used to select a ring-back indicator to provide to the caller based on the available ring-back criteria. The ring-back indicator may be selected from available ring-back indicators. Selection of the ring-back indicator may involve dynamically creating the ring-back indicator based in part on the ring-back criteria. As the ring-back criteria changes, the ring-back indicators may change. The ring-back criteria may be relatively fixed or dynamic and may take various forms. The ring-back criteria used by the ring-back service rules may include presence, location, time zone, and scheduling information of the called party; caller information; date; time of day; device settings; network conditions; as well as any preferences or input of the called party.

With the present invention, a called party can effectively provide different ring-back indicators to the caller as her status changes or other events occur. If the called party is in a meeting, the caller may receive a first ring-back indicator, whereas if the called party is on the phone, the caller may receive a second ring-back indicator. As another example, the called party may have a cellular telephone and be riding a motorcycle. If the ring-back service rules are capable of taking into consideration criteria indicative of the called party riding a motorcycle, a ring-back indicator may be provided to the caller indicating that the called party is relatively available for the call, but it may take her a while to answer the telephone. As such, the ring-back indicator may indicate that the called party will call back shortly, or that the telephone may ring for an extended time before the called party is able to answer the call. Other examples include presenting ring-back indicators based on time and date or location of the called party, as well as her relative ability to communicate with the caller. The ring-back indicator may instruct a caller to use instant messaging or email if immediate communications are necessary. The ring-back indicators may be audible messages from the called party, wherein the messages provide information or instructions to the calling party. Upon appreciating the concepts of the present invention, those skilled in the art will recognize various ways to employ the present invention to their benefit.

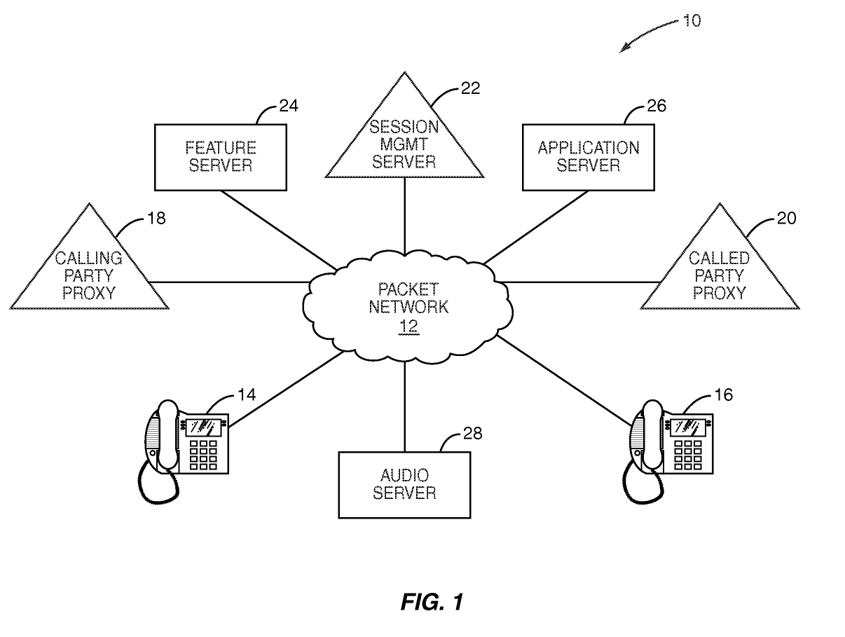

With reference to FIG. 1, a communication environment 10 is illustrated according to a first embodiment of the present invention. In essence, a packet network 12 is capable of allowing a calling party terminal 14 to originate a call to a called party terminal 16, wherein when the call is being presented to the called party terminal 16, a dynamically selected ring-back indicator is presented to the calling party terminal 14 while the called party terminal 16 is alerting the called party that there is an incoming call. In this embodiment, the packet network 12 supports voice-over-packet (VoP) communications, such as voice-over-Internet-Protocol (VoIP) communications. Any type of session control protocol, such as the Session Initiation Protocol (SIP), may be used to establish and control communication sessions between the calling party terminal 14 and the called party terminal 16.

In traditional SIP fashion, a calling party proxy 18 may be associated with the calling party terminal 14, and a called party proxy 20 may be associated with the called party terminal 16. The calling party proxy 18 and the called party proxy 20 may represent the calling party terminal 14 and the called party terminal 16 to other nodes on the packet network 12. Typically, signaling messages for the calling party terminal 14 and the called party terminal 16 are routed through the calling party proxy 18 and the called party proxy 20, respectively. The effective bearer path for the actual voice packets for the call will be routed directly between the calling party terminal 14 and the called party terminal 16, without going through either of the calling party proxy 18 or the called party proxy 20.

Call signaling messages may also be routed through a session management server 22, which is capable of invoking various features in association with the call. For the present invention, the session management server 22 will recognize an incoming call intended for the called party terminal 16 and determine whether to invoke dynamic selection of a ring-back indicator for the call. When dynamic selection of a ring-back indicator is invoked, the session management server 22 will interact with a feature server 24, which will select an appropriate ring-back indicator based on available ring-back criteria. The feature server 24 will store the ring-back service rules, which define the various ring-back indicators to provide in light of available ring-back criteria. The ring-back criteria may be generated by the feature server 24, provided by the session management server 22, or obtained from another application server 26. As indicated above, the ring-back criteria may range from presence information maintained by an application server 26 for the called party, to caller information provided by the session management server 22, to basic date and time information that may be determined at the feature server 24. Although not illustrated, information may be obtained in response to invoking the feature or on a periodic basis from the called party through the called party terminal 16 or other associated computing or communication device.

Once the feature server 24 has identified the appropriate ring-back indicator to provided to the calling party terminal 14 when the call is being presented to the called party terminal 16, the feature server 24 will inform the session management server 22, which may interact with an audio server 28 as well as the calling party proxy 18 or calling party terminal 14 to allow the audio server 28 to provide the selected ring-back indicator to the calling party terminal 14. Those skilled in the art will realize that all the functions unique to this invention attributed to the session management server 22, the feature server 24, the application server 26, and the audio server 28 are logical functions and can all be absorbed into the called party client 16 in a peer-to-peer implementation, if desired. These logical functions can be implemented in virtually any combination of network elements and no implication is intended that a specific set of servers is required to house these functions.

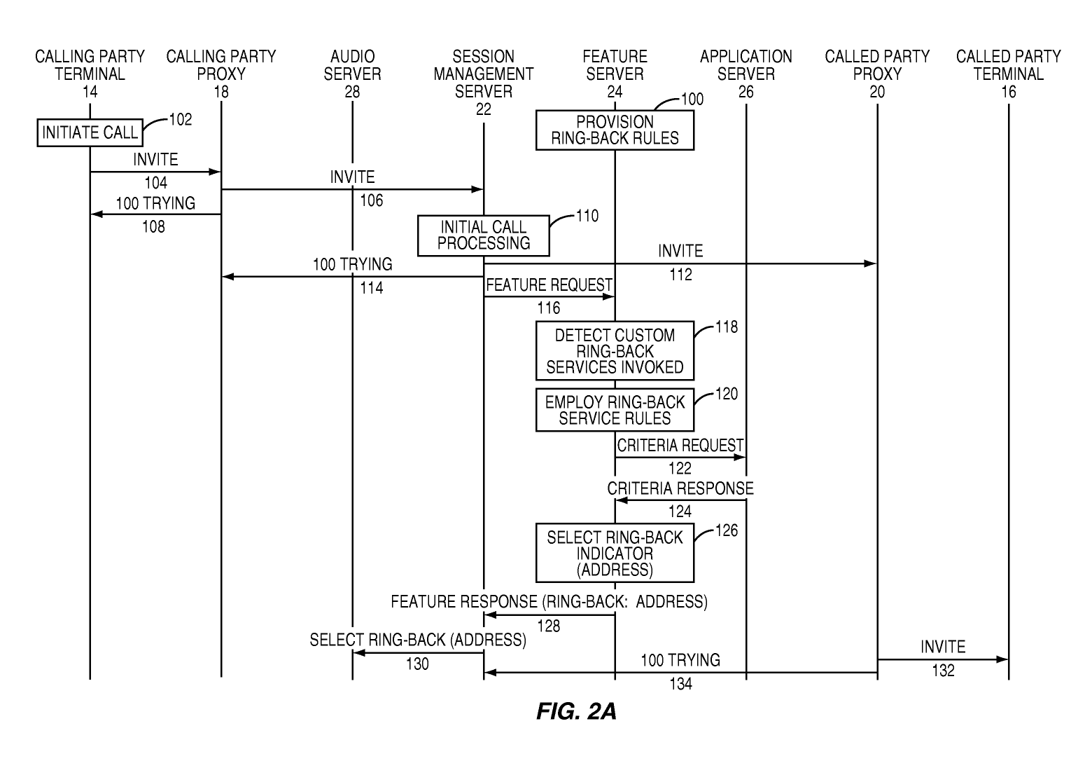

With reference to FIGS. 2A and 2B, a communication flow illustrating the dynamic selection and presentation of ring-back indicators is provided according to the communication environment of FIG. 1. Initially, assume the feature server 24 is provisioned with the ring-back service rules, which allow the feature server 24 to select a ring-back indicator in light of available ring-back criteria (step 100). Next, assume the calling party terminal 14 initiates a call toward the called party terminal 16 (step 102). Using SIP, the calling party terminal 14 will send an Invite message to the calling party proxy 18 (step 104), which will forward the Invite to the session management server 22 (step 106) as well as send a 100 Trying message to the calling party terminal 14 to indicate that the call is proceeding. Upon receiving the Invite, the session management server 22 will provide initial call processing (step 110), forward the call toward the called party terminal 16 by sending an Invite to the called party proxy 20 (step 112), and send a 100 Trying message to the calling party proxy 18 to indicate that the call is proceeding (step 114).

For the initial call processing, the session management server 22 is provisioned to interact with the feature server 24 to determine if any features should be invoked in association with the call (step 116). Based on information provided from the session management server 22, the feature server 24 will detect that the dynamic ring-back feature should be invoked (step 118) and will proceed to employ the ring-back service rules for the called party in light of the available ring-back criteria (step 120). The feature server 24 may need to access an external node, such as the application server 26, to obtain ring-back criteria required by the ring-back service rules. As such, the feature server 24 may send a Criteria Request to the application server 26 (step 122), which will access the requested ring-back criteria and provide it to the feature server 24 in a Criteria Response (step 124). The feature server 24 will then select the appropriate ring-back indicator (step 126) and provide a Feature Response back to the session management server 22 identifying the selected ring-back indicator (step 128). As illustrated, the ring-back indicator is identified by an address, such as a uniform resource locator (URL) corresponding to an audio file or segment stored on the audio server 28.

The session management server 22 will interact with the audio server 28 to select the ring-back indicator to provide to the calling party terminal 14 (step 130). During this interaction, the audio server 28 is instructed to provide the ring-back indicator to the calling party terminal 14. Meanwhile, the called party proxy 20 will respond to the Invite received from the session management server 22 by sending an Invite to the called party terminal 16 (step 132), as well as by sending a 100 Trying message back to the session management server 22 to indicate that the call is proceeding (step 134). At this point, the called party terminal 16 is providing an alerting signal, such as ringing signal, to the called party to indicate that an incoming call is being presented. The called party terminal 16 will send a Ringing message to the called party proxy 20 to indicate that the called party is being alerted to the incoming call (step 136). The called party proxy 20 will then send a 180 Ringing message to the session management server 22 (step 138), which will forward the 180 Ringing message to the calling party proxy 18 (step 140).

In the 180 Ringing message or other message, the session management server 22 will provide ring-back indicia indicating that a special ring-back indicator should be provided. The ring-back indicia may indicate that the ring-back indicator will be received from the audio server 28. The calling party proxy 18 will send a 180 Ringing message to the calling party terminal 14 with or in association with the ring-back indicia (step 142). As such, the calling party terminal 14 will know to listen for the ring-back indicator being played by the audio server 28. During this time, the audio server 28 will begin sending the ring-back indicator to the calling party terminal 14 (step 144), which will provide the ring-back indicator to the calling party while the call is being presented to the called party terminal 16 (step 146).

When the called party terminal 16 answers the call (step 148), the called party terminal will send a 200 OK message to the called party proxy 20 (step 150), which will forward the 200 OK message to the session management server 22 (step 152). The session management server will then forward the 200 OK message to the calling party proxy 18 (step 154), which will forward the 200 OK message to the calling party terminal 14 (step 156). Once the call is answered, the calling party terminal 14 will stop providing the ring-back indicator (step 158) and send an Acknowledgement message (ACK) to the calling party proxy 18 (step 160), which will forward the Acknowledgment message to the session management server 22 (step 162). The session management server 22 will then forward the Acknowledgement message to the called party proxy 20 (step 164), which will forward the Acknowledgement message to the called party terminal 16 (step 166). At this point, voice traffic is provided between the calling party terminal 14 and the called party terminal 16 using VoIP or like streaming media protocol to facilitate a voice session between the calling party and the called party (step 168).

In this example, the called party ends the call (step 170). In response, the called party terminal 16 will send a Bye message to the called party proxy 20 (step 172), which will forward the Bye message to the session management server 22 (step 174). The session management server 22 will forward the Bye message to the calling party proxy 18 (step 176), which will forward the Bye message to the calling party terminal 14 (step 178). The calling party terminal 14 will respond with a 200 OK message (step 180), wherein the calling party proxy 20 will send the 200 OK message to the session management server 22 (step 182), which will forward the message to the called party terminal 16 via the called party proxy 20 (steps 184 and 186). At this point, the call is finished.

Those skilled in the art will recognize that the dynamic ring-back feature may be invoked at any stage in the call signaling path. As such, the functionality described in the session management server 22 and the feature server 24 may be kept separate or may be integrated into a common service node. Further, the dynamic ring-back feature may be employed in either one of the proxies 18, 20 for the calling party or called party, or in terminals. In essence, the concepts of the present invention may be employed at various points in the call signaling path. As such, the above examples are merely for purposes of illustration to help understand the underlying concept of the present invention. Further, the present invention may be employed in network other than packet networks. The present invention may be employed in a circuit-switched network or combination networks, which combine or include both packet and circuit-switched networks.

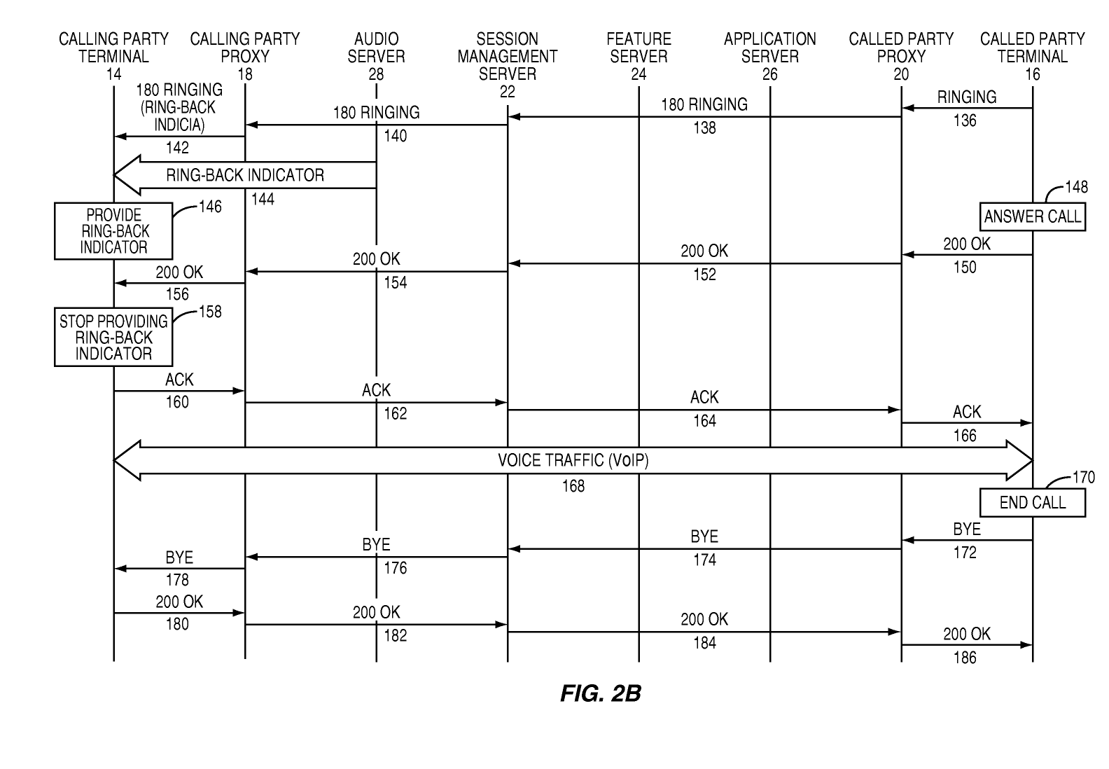

With reference to FIG. 3, an example is provided where the present invention is implemented in a circuit-switched network 30, which is tailored to facilitate cellular communications. As illustrated, a calling party terminal 32, which may represent a mobile telephone, personal digital assistant, or the like, is capable of initiating calls to a called party terminal 34. Although the calling party terminal 32 and the called party terminal 34 are illustrated as being cellular-based terminals, those skilled in the art will recognize that the terminals may employ different configurations and be supported by different types of networks. Continuing with FIG. 3, the calling party terminal 32 is supported by a calling party mobile switching center (MSC) 36, which supports wireless communications with the calling party terminal 32 through a calling party access network 38. The calling party access network 38 may be a cellular network of base stations providing wireless communications with the calling party terminal 32 and may use wired or wireless techniques to connect to the calling party MSC 36, which is associated with the circuit-switched network 30.

Similarly, the called party terminal 34 is supported by a called party MSC 40 via a called party access network 42. For this example, the dynamic ring-back feature is provided by the called party MSC 40, which is capable of interacting with an application server 26′ and an audio server 28′ to obtain additional ring-back criteria, if necessary, as well as facilitate delivery of a selected ring-back indicator to the calling party terminal 32 when the called party terminal 34 is being presented with a call.

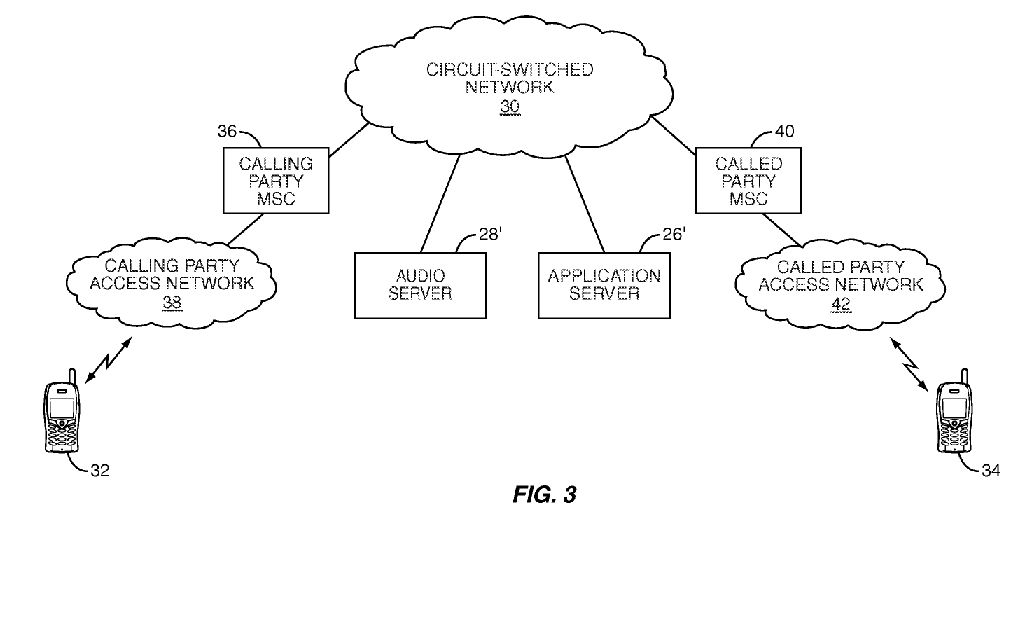

With reference to FIGS. 4A and 4B, a communication flow is provided for selecting and providing a ring-back indicator in the communication environment of FIG. 3. Initially, the called party MSC 40 is provisioned with the ring-back service rules (step 200). Subsequently, assume a calling party initiates a call to the called party terminal 34 from the calling party terminal 32 (step 202). In response, the calling party terminal 32 will send a Setup message to the calling party MSC 36 (step 204), which will send a Call Proceeding message back to the calling party terminal 32 (step 206) to indicate that the call is proceeding, as well as send an Integrated Services User Part (ISUP) Initial Address Message (IAM) toward the called party MSC 40 via the circuit-switched network 30 (step 208). The called party MSC 40 will send a Setup message to the called party terminal 34 (step 210), which may respond with a Call Confirm message to indicate that the Setup message was received (step 212). At this point, the called party terminal 34 will begin alerting the called party that a call is being received (step 214). The called party terminal 34 will also send an Alerting message back to the called party MSC 40 to indicate that the called party is being alerted (step 216).

During this process, the called party MSC 40 may invoke the dynamic ring-back feature by employing the ring-back service rules for the called party (step 218). The called party MSC 40 may access another node, such as the application server 26′, to obtain ring-back criteria required by the ring-back service rules. As such, the called party MSC 40 may send a Criteria Request to the application server 26′ (step 220), which will obtain the requested ring-back criteria and provide the requested ring-back criteria to the called party MSC in a Criteria Response (step 222). Based on the available ring-back criteria and the ring-back service rules, the called party MSC 40 will select an appropriate ring-back indicator (step 224).

The called party MSC 40 may send a message to select the appropriate ring-back indicator to the audio server 28′ (step 226). Again, the information provided to the audio server 28′ may include an address of the ring-back indicator or information necessary to create the ring-back indicator. Notably, the ring-back indicator may be selected from a number of predefined tones or audio segments, as well as be dynamically created based on various calling party information, called party information, or ring-back criteria.

In response to the Alerting message from the called party terminal 34 (from step 216), the called party MSC 40 will send an ISUP Address Complete Message (ACM) to the calling party MSC 36 (step 228). The ISUP ACM or an associated message may provide ring-back indicia indicating that a special ring-back indicator will be provided to the calling party terminal 32. The calling party MSC 36 will send an Alerting message to the calling party terminal 32 to indicate that the call is being presented to the called party (step 230). Again, the Alerting message or associated message may include ring-back indicia indicating that a special ring-back indicator should be provided to the calling party.

In response, the calling party terminal 32 will begin receiving audio for the ring-back indicator from the audio server 28′ to present to the calling party to indicate that the call is being presented to the called party (step 232). The calling party terminal 32 will provide the ring-back indicator to the calling party (step 234). When the called party answers the call (step 236), the called party terminal 34 will send a Connect message to the called party MSC 40 (step 238), which will send an ISUP Answer message toward the calling party MSC 36 (step 240). The calling party MSC 36 will send a Connect message to the calling party terminal 32 to indicate that the call has been answered (step 242). At this point, the calling party terminal 32 will stop providing the ring-back audio and engage in bidirectional communications with the called party terminal 34, wherein the voice traffic is carried over a circuit-switched connection (step 244).

In this example, assume the calling party terminal 32 ends the call (step 246). Upon receiving indication from the calling party that the call is to be ended, the calling party terminal 32 will send a Disconnect message to the calling party MSC 36 (step 248), which will send an ISUP Release message toward the called party MSC 40 (step 250) as well as send a Release message back to the calling party terminal 32 (step 252). Upon receipt of the ISUP Release message, the called party MSC 40 will send a Disconnect message to the called party terminal 34 (step 254), which will respond with a Release message (step 256). Upon receiving the Release message, the called party MSC 40 will send an ISUP Release Complete message toward the calling party MSC 36 (step 258). At this point, the call is finished.

From the above, the present invention allows different ring-back indicators to be selected based on various criteria in response to a call being presented to a called party. A called party may establish unique ring-back service rules employing various types of ring-back criteria to aid in dynamically selecting ring-back indicators to present to a calling party when a call is being presented to the called party. With the present invention, the calling party can receive specially configured ring-back indicators to indicate the relative status of the called party in a timely and effective manner.

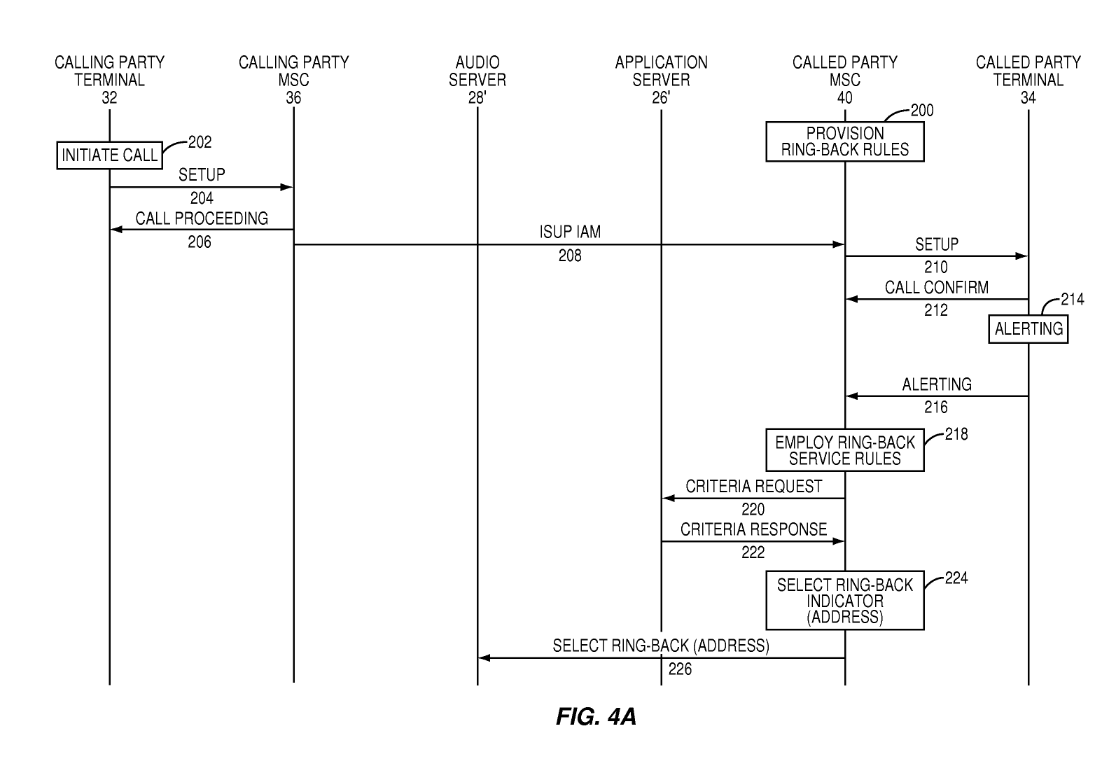

With reference to FIG. 5, a block representation of a session management server 22 is provided. The session management server 22 will have a control system 44 having sufficient memory 46 for the requisite software 48 to operate as described above. The control system 44 will also be associated with a communication interface 50 to facilitate communications over the packet network 12.

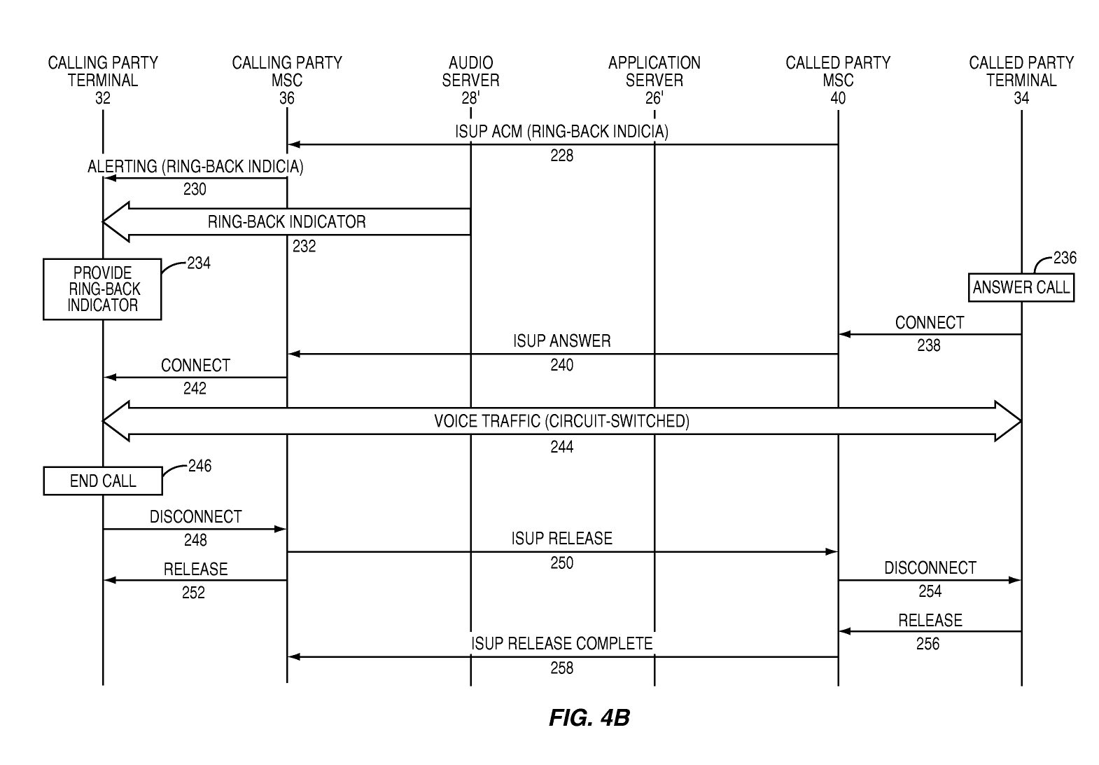

FIG. 6 is a block representation of a called party proxy 20. The called party proxy 20 will have a control system 52 having sufficient memory 54 for the requisite software 56 to operate as described above. The control system 52 may also be associated with a communication interface 58 to facilitate communications over the packet network 12.

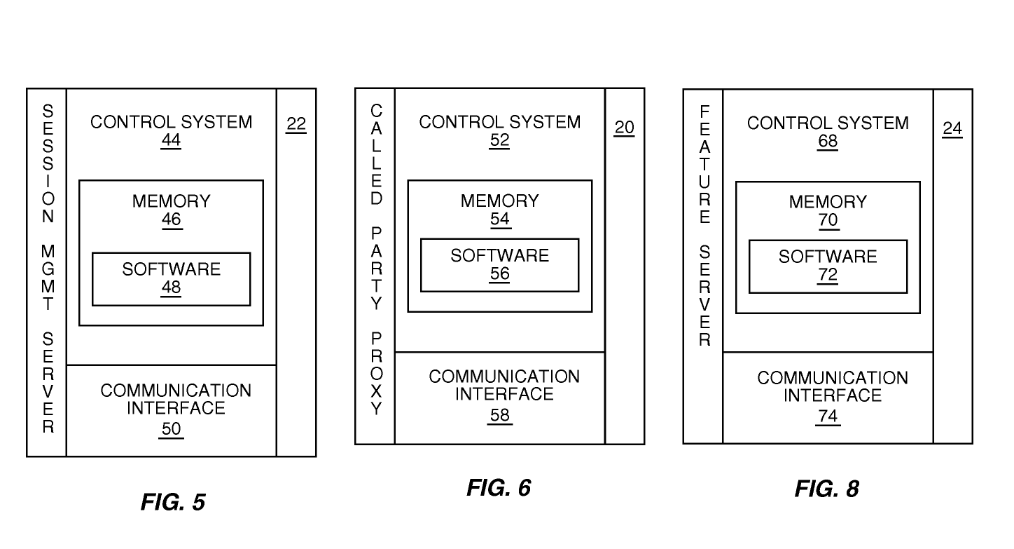

With reference to FIG. 7, a called party MSC 40 is illustrated. The called party MSC 40 may include a control system 60 associated with a first communication interface 62 and a second communication interface 64. The first communication interface 62 is adapted to facilitate communications over a core circuit-switched network, such as the circuit-switched network 30, and the second communication interface 64 is configured to communicate with the various terminals via an appropriate access network. The first and second communication interfaces 62, 64 may be coupled together through an appropriate switching matrix 66 to facilitate circuit-switched communications.

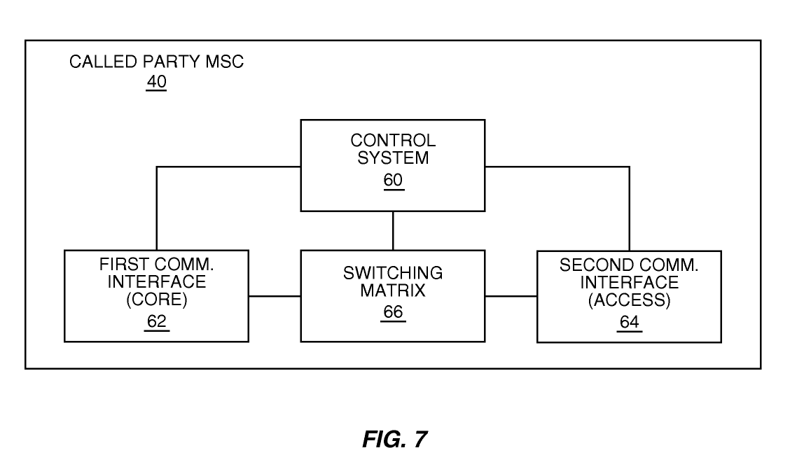

FIG. 8 is a block representation of a feature server 24. The feature server 24 will have a control system 68 having sufficient memory 70 for the requisite software 72 to operate as described above. The control system 68 may also be associated with a communication interface 74 to facilitate communications over the packet network 12.

Those skilled in the art will recognize improvements and modifications to the preferred embodiments of the present invention. All such improvements and modifications are considered within the scope of the concepts disclosed herein and the claims that follow.

What is claimed is:

1. A method comprising:
recognizing a call is being initiated from a calling party terminal and directed to a called party terminal; and
dynamically selecting a ring-back indicator to provide to the calling party terminal when the call is presented to the called party terminal based on ring-back criteria, such that different ring-back indicators are selected for different calls as the ring-back criteria change.

2. The method of claim 1 further comprising effecting delivery of the ring-back indicator to the calling party terminal to alert a calling party that the call is being presented to the called party terminal.

3. The method of claim 2 wherein effecting delivery of the ring-back indicator further comprises instructing an audio server to deliver the ring-back indicator to the calling party terminal.

4. The method of claim 1 wherein selecting the ring-back indicator further comprises identifying ring-back service rules for a called party upon identifying the call, the ring-back service rules defining different ring-back indicators to be selected for different ring-back criteria.

5. The method of claim 4 further comprising receiving provisioning information from the called party and creating the ring-back service rules based on the provisioning information.

6. The method of claim 1 wherein selecting the ring-back indicator further comprises accessing at least a portion of the ring-back criteria from a remote node.

7. The method of claim 1 wherein the ring-back criteria further comprise at least one of the group consisting of presence information, location information, time zone information, and scheduling information associated with a called party or a called party device.

8. The method of claim 1 wherein the ring-back criteria further comprise at least one of the group consisting of date and time of day.

9. The method of claim 1 wherein the ring-back criteria further comprise at least one of the group consisting of calling party information and calling party device information.

10. The method of claim 1 wherein the ring-back criteria further comprise information provided by a called party.

11. The method of claim 1 wherein the ring-back indicator is audibly provided to a calling party.

12. The method of claim 1 further comprising:
receiving a first call signaling message to originate a call from the calling party terminal to the called party terminal; and
sending a second call signaling message to originate the call from the calling party terminal to the called party terminal.

13. A call processing node comprising:
at least one communication interface; and
a control system associated with the at least one communication interface and adapted to:
recognize a call is being initiated from a calling party terminal and directed to a called party terminal; and
dynamically select a ring-back indicator to provide to the calling party terminal when the call is presented to the called party terminal based on ring-back criteria, such that different ring-back indicators are selected for different calls as the ring-back criteria change.

14. The call processing node of claim 13 wherein the control system is further adapted to effect delivery of the ring-back indicator to the calling party terminal to alert a calling party that the call is being presented to the called party terminal.

15. The call processing node of claim 14 wherein to effect delivery of the ring-back indicator, the control system is further adapted to instruct an audio server to deliver the ring-back indicator to the calling party terminal.

16. The call processing node of claim 13 wherein to select the ring-back indicator, the control system is further adapted to identify ring-back service rules for a called party upon identifying the call, the ring-back service rules defining different ring-back indicators to be selected for different ring-back criteria.

17. The call processing node of claim 16 wherein the control system is further adapted to receive provisioning information from the called party and create the ring-back service rules based on the provisioning information.

18. The call processing node of claim 13 wherein to select the ring-back indicator, the control system is further adapted to access at least a portion of the ring-back criteria from a remote node.

19. The call processing node of claim 13 wherein the ring-back criteria further comprise at least one of the group consisting of presence information, location information, time zone information, and scheduling information associated with a called party or a called party device.

20. The call processing node of claim 13 wherein the ring-back criteria further comprise at least one of the group consisting of date and time of day.

21. The call processing node of claim 13 wherein the ring-back criteria further comprise at least one of the group consisting of calling party information and called party device information.

22. The call processing node of claim 13 wherein the ring-back criteria further comprise information provided by a called party.

23. The call processing node of claim 13 wherein the ring-back indicator is audibly provided to a calling party.

24. The call processing node of claim 13 wherein the control system is further adapted to:
receive a first call signaling message to originate a call from the calling party terminal to the called party terminal; and
send a second call signaling message to originate the call from the calling party terminal to the called party terminal.
